(19) United States
(12) Patent Application Publication
(10) Pub. No.: US 2004/0253160 A1
(43) Pub. Date: Dec. 16, 2004

(54) Method of neutralizing acid rain

(76) Inventor: Kenneth Mitchell Jones, Alexandria, VA (US)

Correspondence Address: Kenneth Mitchell Jones, 7113 Vantage Drive, Alexandria, VA, 22306, US

(21) Appl. No.: 10/863,487

(22) Filed: Jun. 9, 2004

Related U.S. Application Data
(60) Provisional application No. 60/477,061, filed on Jun. 10, 2003.

(51) Int. Cl. B01D 53/52

(52) U.S. Cl. 423/230

(57) ABSTRACT

The present invention is directed to a method of ameliorating atmospheric acidic pollutants that are generating in large quantities by industrial processing such as electricity producing power plants, metal ore smelting and others which release large quantities of sulfur and nitrogen oxides into the atmosphere. The method neutralizes atmospheric acidic pollutants by the dispersal of microscopic, preferably sub-microscopic, particles of finely divided or pulverized acid neutralizing material. The finely divided or pulverized acid neutralizing material is preferably a metal carbonate, metal oxide or a mixture thereof where the metal may be one or more of Ca, Mg, Fe, Zn, Cu, B, Cr, Co, Cu, Mn, Mo, Ni, Na, K, Sn, V. The particles may contain other components that make the particles more environmentally friendly or healthy for plant and animal organisms. The other components may include chloride, iodine, phosphorus (preferably in the form of a MPO₄, M′HPO₄, M″H₂PO₄), Se, S, amino acids, vitamins, any other known nutrient, mineral, etc.

### CROSS REFERENCE TO RELATED APPLICATIONS

Pursuant to 35 U.S.C. section 119, the benefit of priority from provisional application Ser. No. 60/477,061, with a filing date of Jun. 10, 2003, is claimed for this non-provisional application.

### FIELD OF INVENTION

The present invention relates to a process for neutralizing the acidity of acid rain, atmospheric acidic precipitation more generally, and more particularly to the choice of materials and their physical form for release into the atmosphere for neutralizing the acidity of acid rain.

### BACKGROUND OF THE INVENTION

Acid rain is caused when pollutants released from activities such as the burning of fossil fuels chemically react with other substances in the atmosphere to form acids. When these acids are carried down from the atmosphere in rain, fog, or snow, they can harm fish, damage high altitude forests, and contribute to the deterioration of buildings and historical monuments. The pollutants that cause acid rain also have been known to impair visibility in many regions of the nation, including the scenic vistas of our national parks.

The Environmental Defense Fund has reported showing a correlation between the amount of sulfur dioxide, SO₂, released into the atmosphere and the amount of acid rain that forms downwind even at great distances from the source of the sulfur dioxide.

Another source of sulfur dioxide emissions is the eruption of volcanos and geysers. It is contemplated as part of the present invention that governmental or non-governmental organizations use the methods disclosed herein to ameliorate the detrimental effects of sulfur dioxide emissions from these and other natural sources.

“Clean” or unpolluted rain has a slightly acidic pH of 5.6, because carbon dioxide and water in the air react together to form carbonic acid, a weak acid. Around Washington, D.C., however, the average rain pH is between 4.2 and 4.4. The extra acidity in rain comes from the reaction of air pollutants, primarily sulfur oxides and nitrogen oxides, with water in the air to form strong acids (like sulfuric and nitric acid).

The most common source of sulfur oxides and nitrogen oxides is from acidic substances formed by man-made sources such as the combustion of fossils fuels, especially coal and lignite, with the release of the combustion products into the atmosphere. Unfortunately, much of the coal and lignite found in this country in commercial quantities contains sulfur in varying quantities. When such sulfur-containing coal and lignite materials as well as other sulfur-containing fossils fuels are burned, sulfur oxides are produced and are emitted into the atmosphere, unless very costly and elaborate measures are undertaken to remove the sulfur oxides from the flue gases coming from the combustion equipment. In the United States, around 45% of the electricity is generated in power plants that burn coal. Other fossils fuels such as gasoline and diesel fuels which contain sulfur also contribute to acid rain by the same mechanism as the burning of coal.

Another use of the present invention is for the neutralization of acid rain produced by the emission of sulfur oxides from sources such as the roasting of metal sulfide ores including but not limited to cupper sulfide. Many metal production and processing methods use the formation of metal sulfides for part of purification process for obtaining the metal. When such metal sulfides are roasted, sulfur oxides are produced and subsequently released into the atmosphere which then contribute to the problem of acid rain.

The present invention is not limited in its application to any particular source of pollutants that cause acid rain but applies to any source of pollutants that cause acid rain.

The Environmental Defense Fund has reported finding serious health problems in asthmatics near Southwestern U.S. copper smelters. Other known ill effects of acid rain include damage to lakes and the wildlife living therein, damage to building, statues, carvings particularly limestone objects.

The most commonly used stone building materials are marble, limestone and sandstone. Marble is crystallized limestone. All three of these materials include calcite among their components, which is considered to be mainly responsible for their vulnerability to acid rain since calcite can be dissolved by acid rain. Accordingly, acid rain is causing damage to the priceless statues and buildings of antiquity made of these materials such as the Parthenon and its statues as well as many more modern buildings, particularly those having carved structures thereon which carved structures are slowly eaten away by the acid rain.

Acid rain is probably a major contributing factor to sinkholes forming in many locations since the acid rain can cause the dissolution of limestone first near the surface as the rain soaked through the ground.

Accordingly there is a great need to reduce the problem of acid rain. Fortunately, the major cause of acid rain is now rather well understood. The methods used in the past to deal with acid rain have included governments liming lakes with calcium carbonate CaCO₃ to neutralize acid rain that had fallen and run off into the lake. However, such heroic efforts are very limited in their remedial effect and scope.

More generally, because of the problems caused by acid rain, there has been a number of rather strict legislative and regulatory restrictions or limits placed on the amount of contaminants, such as sulfur oxides, that can be emitted into the atmosphere.

It is well known that energy sources, such as coal, lignite, oil and the like, that contain sulfur will produce large quantities of sulfur oxides. To satisfy the various legislative and regulatory restrictions on the amount of sulfur oxides that are emitted into the atmosphere by burning sulfur-containing coal and lignite, various types of methods and apparatus have been utilized to minimize such emissions. Such methods and apparatus have added to the cost of the conversion of the sulfur-containing coal or lignite into useful energy. In fact, in order to meet rigid requirements pertaining to emissions of sulfur oxides, the cost of various methods and apparatus for reducing sulfur oxide emissions, such as by use of complicated and costly scrubbers, precipitators and the like, have virtually made some coal and lignite supplies unattractive for the production of needed energy.

Therefore, it is desirable that inexpensive and practical methods be developed for alleviating the problem of acid rain caused by the emission of sulfur-containing air contaminants as well as other acid producing emissions. Moreover, it is unfortunate that previous methods of alleviating the problem of acid rain have relied on either removing the sulfur from the fossil fuel or capturing the sulfur dioxide produced from the burning of the fossil fuel before its release into the atmosphere since the combustion of sulfur releases substantial amounts of useful heat energy.

Much of the sulfur in fossil fuels, when combusted, forms SO₂ rather than SO₃. Capturing SO₂ is much more difficult than capturing SO₃ because SO₂ reacts slowly and incompletely with water and bases in scrubbing towers while SO₃ reacts very rapidly. As a result, even the best technologies for capturing SO₂ in flue gases still release much of the SO₂ into the atmosphere. The present invention makes an improvement in dealing with SO₂ in the atmosphere because when treating SO₂ in the atmosphere, even a slow chemical reaction can go to completion. On the other hand, trying exclusively to deal with SO₂ within a flue stack of a combustion device is almost certainly impossible because of the short amount of reaction time available in the flue stack. Also dealing with SO₂ in the atmosphere can be much more economical because a dealing with SO₂ in the atmosphere permits slower and milder chemical reactions to be utilized in dealing with the pollutant.

### BRIEF SUMMARY OF THE INVENTION

The present invention provides for the neutralization of acid rain from the emissions of various sulfur oxides and other acidic chemical materials produced from various industrial and natural sources. The present invention provides a convenient and safe remedy for the acid rain producing effects of the sulfur oxides and other acidic chemical materials from various sources of such emissions.

The present invention allows sulfur-containing fossil fuels including but not limited to coal or lignite to be used for combustion in conventional combustion equipment in spite of their sulfur oxides air emissions. The present invention also permits governments or other institutions to ameliorate the ill effects of natural sources of various sulfur oxides and other acidic chemical materials including the eruptions of volcanoes and geysers.

Another advantage of the present invention is that it will allow emission scrubbers to concentrate on other harmful emissions from fossil fuels or the roasting of ores. Such harmful emissions include lead and mercury.

The present invention provides a remedy for acid rain or other precipitations which comprises dispersing into the atmosphere a finely divided or pulverized material that reacts with any acidic chemical substances that is present in the atmosphere to form a more nearly pH neutral material which results in a more nearly pH neutral rain or other precipitation. In other words, the finely divided or pulverized material is a chemical base that neutralizes acidic chemical materials that are present in the atmosphere. However, it is preferred that the chemical base is a mild base, and more preferably is a harmless, environmentally inert, chemically basic material. More preferably the finely divided or pulverized material is an inexpensive material and even more preferably the finely divided or pulverized material is beneficial to the environment.

Another advantage of the instant invention is that some of the finely divided or pulverized acid neutralizing material after its dispersal into the atmosphere may settle, prior to its reaction in the atmosphere with a chemically acidic material, over a large area where the acid neutralizing material will remain available to neutralize any acid rain that later precipitates.

The finely divided or pulverized acid neutralizing material may be any acid neutralizing material but an inexpensive acid neutralizing material is preferred. Of the potential acid neutralizing materials, inexpensive inorganic materials are especially preferred. The inorganic material can be at least one material selected from: an oxide of sodium, potassium, calcium, magnesium and mixtures thereof; a hydroxide of sodium, potassium, calcium, magnesium and mixtures thereof; a carbonate of sodium, potassium, magnesium, calcium and mixtures thereof; or dolomite and mixtures thereof. The finely divided or pulverized acid neutralizing material may further include nutritive components such that the finely divided or pulverized acid neutralizing material is beneficial to humans, animals and plants, and is beneficial generally to the environment.

In a preferred embodiment of this invention, it is desirable to reduce the average particle size of the finely divided or pulverized acid neutralizing material to as small as is practical. The term “average particle size” is used as it is commonly understood in the art. As the particle size of the finely divided or pulverized acid neutralizing material decreases, the efficiency of the instant invention in neutralizing acid rain increases for a given amount of the dispersed inorganic materials. Thus, there is no minimum size restriction placed on the particle size of the finely divided or pulverized acid neutralizing material that is dispersed in the atmosphere. However, the particle size of the finely divided or pulverized acid neutralizing material will preferably have an average particle size of 50 μm or less, more preferably 25 μm or less, and more preferably much smaller than 25 μm in order to achieve the desired reductions in acid rain. It is still more preferred that the average particle size of the finely divided or pulverized acid neutralizing material will be 5 μm or less, more preferably 1 μm or less, more preferably 0.4 μm or less, more preferably 0.1 μm or less, and more preferably 0.02 μm or less.

The particulates comprising the finely divided or pulverized acid neutralizing material of the instant invention do not contain more than insubstantial amounts of water insoluble or non-metabolizable components such as silicates, e.g. from cement operations, construction sites, farm operations and traffic on unpaved roads, and do not contain more than a trace of toxic components (such as but not limited to toxic components from mining activity and metal processing). For the purposes of this patent application, an insubstantial amounts of insoluble components means less than 1% by weight of the total material is insoluble components, more preferably less than 0.1% by weight of the total material, and even more preferably less that 0.01% by weight of the total weight of an average particle. A trace amount of toxic components is not more than 0.01% by weight of the total weight of the acid neutralizing material, more preferably not more than 0.001% by weight of the total weight of the acid neutralizing material, and more preferably not more than 0.0001% by weight of the total weight of the acid neutralizing material. It is intended that the particles of the instant invention are compatible with the envirornent or metabolizable within an organism. Moreover, even after the particles have undergone chemical reactions in the atmosphere, then the chemically transformed particles are still compatible with the environment or metabolizable within an organism, regardless of how the organism consumes the particles, e.g. inhalation, ingestion, etc.

Selecting a finely divided or pulverized acid neutralizing material wherein the average particle size of the finely divided or pulverized acid neutralizing material is less than 0.4 μm in diameter is especially preferred. The particle may be released into the atmosphere and once dispersed, the particles should cause very little interference with sunlight since the wavelength of the shortest wavelength light, i.e. blue light, is 0.4 μm.

The intent of the present invention is that a major fraction of the finely divided or pulverized acid neutralizing material is dispersed into the atmosphere for traversal over a considerable range, preferably a considerable portion of the range over which the acidic or acid-forming combustion products are likely to travel after emission from a source. Such distances are contemplated to include about 1 mile, more preferably about 5 miles, more preferably about 20 miles, more preferably about 100 miles, more preferably about 400 miles, about 1200 miles, more preferably about 3000 miles, more preferably about 10,000 miles, more preferably about 25,000 miles and even further, i.e. multiple trips around the earth.

It is the intent of a preferred embodiment of the present invention that a major fraction of the finely divided or pulverized acid neutralizing material is dispersed into the atmosphere, such that a major fraction of the finely divided or pulverized acid neutralizing material reacts in the atmosphere with acidic chemical materials to neutralize the acidic chemical materials in the atmosphere to produce more nearly pH neutral chemical materials that are, at worst, inert to the environment for plants, animals, humans and other life forms and are actually beneficial for the environment.

Another aspect of the present invention relates to a method by which a governmental organization or an organization acting with governmental authority can ameliorate the effects of acidic pollutants entering its territory by crossing its borders from another territory. The organization can also ameliorate the effects of acidic pollutants generated within its territory. This method requires measurement and estimation of the amount of acidic pollutants in a given region, i.e. volume of atmosphere and corresponding surface area of the earth. Alternatively the method requires measurement and estimation of the amount of acidic pollutants entering a given region. Such methods are well known and are not an object of this invention.

Another embodiment of the present invention pertains to the situation in which an excess of acid neutralizing particles is discharged into the atmosphere by a company such that the discharge bears a proportionality to the amount of acidic chemical materials emitted by the company, e.g. 110 molar %-1000 molar % (or even higher) of the daily emissions of the company. It is to be understood that 100 molar % refers to an amount of acid neutralizing particles that is exactly stoichiometric for neutralizing a given amount of acidic materials. A stoichiometric amount of the acid neutralizing particles is for neutralizing the acidic chemical substances emitted by the company while the excess of the acid neutralizing particles will be available to neutralize the acidic chemical substances emitted by sources that may not be subject to control by the governing authority of the region.

The present invention in a preferred embodiment applies to releasing at least a stoichiometric amount of acid neutralizing material for neutralizing the acid producing chemical substances from one or more sources of combustion products

The present invention in a preferred embodiment applies to the release of acid neutralizing particles from mountain tops or other elevated locations for better dispersal.

The present invention in a preferred embodiment applies to release from locations near to the source of the combustion products.

The present invention in a preferred embodiment applies to the release of acid neutralizing particles from airplanes, locomotives or other moving vehicles.

The present invention applies to heating the finely divided or pulverized acid neutralizing material prior to release to better facilitate dispersal.

The present invention applies to releasing the finely divided or pulverized acid neutralizing material during any type of weather condition including sunny days, rainy days, partly cloudy days, etc.

In the present invention, the released particles can serve other purposes, such as reflecting sunlight to produce cooler weather, such as during forest fires in the summertime. For the purpose of reflecting sunlight, the particles must be large enough to reflect light—greater than about 0.7 μm. For the purpose of reflecting heat from the sun, the particles must preferably be at least about as large as the longest infrared wavelengths of electromagnetic radiation. Infrared radiation in its broadest definition extends from 0.7 μm to 1000 μm. However, the shortest wavelength and intermediate wavelength infrared radiation is generally considered to span only from 0.7 μm to 20 μm. For energy content of the sun, these two bands of infrared radiation contain most of the energy of the infrared band. Accordingly, particles that can reflect the infrared radiation of wavelength shorter than 20 μm will achieve much cooling effect by reflection of the sun's radiation. Particles having an average particle size of 50 μm or less can fulfill this requirement.

It is the intent that the present invention can be used to ameliorate the acid rain producing effects of the emissions of a plurality of combustion powered transportation devices, e.g. automobiles of all types, e.g. cars, trucks, snowmobiles, other transportation devices such as motor boats, etc.

It is the intent that the present invention can be used to ameliorate the acid rain producing effects of sulfur oxides and other acidic materials from natural sources such as volcanoes, geysers, etc.

It is another advantage of the instant invention that a significant fraction of the particles released will ultimately be captured or absorbed by the oceans. Particularly, if the finely divided or pulverized acid neutralizing material contains iron, then the particles will not only help to neutralize acidic pollutants over landed regions of the earth, but will also provide iron to the surface waters of the oceans. Once the particles are absorbed by the oceans, then iron will be released to help to fertilize the growth of carbon dioxide-absorbing organisms, such as algae. It is a current theory the providing iron to the surface waters of the oceans could spawn a sharp increase in algae which could then act as a giant sponge to take up carbon dioxide emitted from factories, cars and other fossil fuel burners believed responsible for global warming.

Another advantage of the present invention is that it will allow emission scrubbers to concentrate on other harmful emissions such as lead and mercury.

### DETAILED DESCRIPTION OF THE INVENTION

Acid rain is caused when pollutants released from activities, such as the burning of fossil fuels, chemically react with other substances in the atmosphere to form acids. The major chemical substances that cause acid rain are sulfuric acid and nitric acid. Both sulfuric acid and nitric acid form from chemical substances that are produced in combustion processes using air as the oxidizing agent, which is the vast majority of combustion processes.

Current U.S. law allows almost 9 million tons of sulfur dioxide to be emitted into the atmosphere annually. The sulfur dioxide, once in the atmosphere, is chemically converted to either sulfurous acid H₂SO₃ or sulfuric acid H₂SO₄. The sulfurous or sulfuric acid returns to earth either in precipitation or by dry deposit where it leads to the leaching from the soil important mineral cations such as Ca²⁺, Mg²⁺, Feⁿ⁺, Zn²⁺, etc. or causes damage to buildings and harm to plants, etc. The present invention provides a method of ameliorating the harmful effects of the legally emitted acids or their precursors, essentially converting the pollutant materials into environmental nutrients or at worst, environmentally inert materials. The present invention provides for the neutralization of much of the atmospheric acidic materials by discharging finely divided or pulverized acid neutralizing material into the atmosphere in proportions to neutralize such atmospheric acidic materials either before or after they leave the atmosphere.

In the present invention, acidic chemical materials is meant to include all chemical substances which are acidic when emitted from a source or become acidic during their transient time is the atmosphere. Such emissions are termed in this disclosure to have acid potential where the emissions include materials that are acidic when released and/or have the potential to become acidic after release from the source. For example, the chemical substances include sulfur dioxide SO₂ which combines with water to form sulfurous acid which is mildly acidic but sulfur dioxide SO₂ is also oxidized in the atmosphere and combines with water to form sulfuric acid, a very strong acid. Acid potential is simply a convenient term meaning the total amount of acid chemical substances that form from the emissions from a source.

A source of emissions is meant to include all man-made sources as well as natural sources. For example, man-made sources include power plants which combust fossil fuel, especially coal, to produce power such as electricity and mechanical power. The natural sources of emissions include volcanos and geysers, etc.

When any fossil fuel is combusted in a process that uses air as the oxidizing agent, then within the combustion chamber, nitrogen N₂ reacts with oxygen O₂ to form nitric oxide NO. The nitric oxide after being emitted from the combustion chamber and released into the atmosphere further reacts with oxygen in the atmosphere to form nitrogen dioxide (NO₂) which then reacts with water in the atmosphere to form nitric acid HNO₃ and more nitric oxide (see eqns. 1-3).

N₂(g)+O₂(g)→NO(g) (1)

NO(g)+1/2O₂(g)→NO₂(g) (2)

3 NO₂(g)+H₂O(g)→2 HNO₃+NO(g) (3)

Similarly when sulfur in any of its various forms is present in the fossil fuel, the sulfur combusts to form predominantly sulfur dioxide. When the sulfur dioxide is released into the atmosphere, the sulfur dioxide undergoes further reaction in the atmosphere to form sulfuric acid (see equation 4):

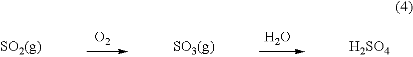

The nitric and sulfuric acids, or more generally speaking acidic chemical materials, condense with atmospheric water to produce various forms of precipitation including acid rain, acid fog, acid snow, etc.

The present invention solves the problem of acid rain (and other forms of acidic precipitation) by dispersing finely divided or pulverized acid neutralizing material into the atmosphere to react with the acidic chemical materials in the rain water to produce a more nearly pH neutral rainwater that is safe for the environment. More particularly, the present invention encompasses the process of dispersing from one or more sites the finely divided or pulverized acid neutralizing material into the atmosphere to neutralize acidic chemical materials from one or more sources of the acidic chemical materials or their precursors.

However, a major problem with the release of dust into the atmosphere is a reduction in visibility. Dust tends to cause the air to become hazy. The instant invention avoids the problem of haze to a major extent by the use of sub-visible size particles in a preferred embodiment. The wavelengths of light from blue to red are 400 nm to 750 nm (0.4-0.75 μm), respectively. Accordingly, particles of finely divided or pulverized acid neutralizing material having an average particle size of less than 0.4 μm can be expected to reduce visibility much less than material having an average particle size of greater than 0.4 μm. Even less obstruction of light, i.e. haze, can be expected from the use of finely divided or pulverized acid neutralizing material having an average particle size of substantially less than 0.4 μm, e.g. 0.1 μm to 0.01 μm.

Any known method and equipment for reducing the size of the finely divided or pulverized acid neutralizing material can be utilized, such as conventional grinding and crushing in crushers, hammer mills and the like. As used throughout this specification, the term “pulverized” finely divided or pulverized acid neutralizing material shall mean finely divided or pulverized acid neutralizing material that has an average particle size of 50 μm or less, and preferably much smaller than 50 μm.

In fact, the smaller the particle size of the finely divided or pulverized acid neutralizing material, then potentially the greater the fraction of the particle that can be used to neutralize acidic chemical substances formed from the emission from combustion processes for a few reasons. These reasons include greater total surface area available for a given mass of particles which implies greater chemical availability of the acid neutralizing material for reacting with acidic chemical materials. Another reason is that the finely divided or pulverized acid neutralizing material is more likely to travel a substantial fraction of the pathway followed by the acidic chemical materials assuming that the finely divided or pulverized acid neutralizing material is released into the atmosphere in the proximity of the emissions of the combustion exhaust. Another reason is that smaller particles are more likely to allow all of the finely divided or pulverized acid neutralizing material to react to completion, thus using the finely divided or pulverized acid neutralizing material more efficiently.

It is also a characteristic of the present invention that the finely divided or pulverized acid neutralizing material, if inhaled, will dissolve and be absorbed or metabolized by an organism. Even after the finely divided or pulverized acid neutralizing material has reacted in the atmosphere with acidic components in the atmosphere, the finely divided products, if inhaled, also will dissolve and be absorbed or metabolized by an organism.

For example, when a calcium carbonate particle comes into contact with an acidic drop of rain containing sulfuric acid, then the chemical reaction shown in equation (5) will occur:

CaCO₃(s)+H₂SO₄(aq)→Ca²⁺(aq)+SO₄²⁻(aq)+CO₂(g)+H₂O(l) (5)

forming water soluble calcium sulfate CaSO₄. Calcium sulfate has a water solubility of about 0.2 grams per 100 ml water at 20° C. Calcium carbonate over a hundred times less soluble than calcium sulfate. If nitric acid is present in the rain drop, then the following chemical reaction will occur to form calcium nitrate:

CaCO₃(s)+2 HNO₃(aq)→Ca²⁺(aq)+2 NO₃¹⁻(aq)+CO₂(g)+H₂O(l) (6)

If the carbonate particle also contains magnesium, then magnesium sulfate and magnesium nitrate will be present in the product. Calcium and magnesium nitrate are very soluble, and magnesium sulfate is much more soluble than calcium sulfate.

The present invention also contemplates the use of acid neutralizing particles wherein the acid neutralizing particles have a high porosity. Such acid neutralizing particles include metal carbonate particles. Metal carbonate particles having a high porosity may be formed by known methods including spray pyrolysis of metal bicarbonate solutions. Another technique is known as Rapid Expansion of a Supercritical Solution (RESS). Whether the metal bicarbonate solution is supercritical or subcritical, the principles involved for their formation are the same. As carbon dioxide gas is formed from the decomposition of the metal bicarbonate in solution as it is sprayed, preferably while being heated as it is sprayed, a metal carbonate rapidly precipitates out of solution and forms metal carbonate particles. The particles tend not only to be very small but also tend to be highly porous. Porous particles are more likely to allow all of the finely divided or pulverized acid neutralizing material to react to completion. Lerner (U.S. Pat. No. 4,865,828) discloses another advantage of carbonate particles. Namely carbonate particles become more porous when the carbonate reacts with SO₂ and O₂. Lerner '828 is incorporate herein in its entirety.

Patents disclosing the forming and spraying of calcium bicarbonate solutions include Faatz U.S. Pat. No. 4,272,498 and Veltman U.S. Pat. No. 4,629,130, both of which are incorporated herein by reference in their entirety. Veltman also disclosing grinding limestone in the presence of a carbonic acid solution to produce finely divided limestone particles. Smith (U.S. Pat. No. 4,582,731) discloses spraying solutions of a material dissolved in a supercritical fluid to form particles having an average particle size of less than 0.1 μm. Smith '731 also discloses changing solute concentration to change particle size. Smith (U.S. Pat. No. 4,734,451) discloses spraying solutions of a material dissolved in a supercritical fluid to form particles having an average particle size of less than 0.02 μm and changing solute concentration to change particle size. Both Smith '731 and Smith '451 are incorporated herein by reference in their entirety. Faatz in particular teaches that there is no upper limit on the carbon dioxide pressure that may be used in his process.

Solutions for forming acid neutralizing particles other than calcium bicarbonate solution may be used in place of the calcium bicarbonate solution. For example, the acid neutralizing particle precursor solution to be sprayed may be a carbonate of sodium, potassium, magnesium, mixtures thereof; or dolomite, calcite and mixtures thereof. It is also possible to spray solutions of an oxide of sodium, potassium, magnesium and mixtures thereof; a hydroxide of sodium, potassium, calcium, magnesium and mixtures thereof. Any of the solutions cited above may also include in the mixture a carbonate, oxide and/or hydroxide of calcium.

For forming larger particles by the method taught by Faatz '498, it is generally preferable to use higher concentrations, even saturated solutions, of the acid neutralizing particle precursor solution and maintaining the acid neutralizing particle precursor solution at a lower temperature prior to spraying the acid neutralizing particle precursor solution. Naturally, lower concentrations of the acid neutralizing particle precursor solution and heating the acid neutralizing particle precursor solution to higher temperatures prior to spraying the acid neutralizing particle precursor solution favors the formation of finer and more porous acid neutralizing particles. Moreover it is possible to collect the acid neutralizing particles following their discharge from a sprayer with recycling of the solvent of the acid neutralizing particle precursor solution including any dissolved CO₂ in order to reduce the amount of CO₂ that is released into the atmosphere from the production of the acid neutralizing material particles. Once an adequate batch of the acid neutralizing particles has been collected, then the acid neutralizing particles may be discharged in a separate operational step from the making of the particles.

Furthermore, the effectiveness of the present invention does not depend upon the presence of rain or other atmospheric precipitation. For example, when sulfur dioxide is oxidized in the atmosphere to form sulfur trioxide and liquid water is not present, the sulfur dioxide quickly reacts with water vapor to form vaporous sulfuric acid or a sulfuric acid aerosol. With a particle of calcium carbonate, the following reaction will occur at the surface of the particle:

CaCO₃+H₂SO₄→CaSO₄+CO₂+H₂O (7)

Note that the chemical products of the reaction (7) are the same as the chemical products of the reaction (5) except that calcium sulfate as a solid is formed, thus indicating how the present invention is effective in neutralizing acidic chemical materials in the atmosphere regardless of the presence of atmospheric precipitation.

Suitable examples of inorganic materials that can be utilized in the present invention include sodium oxide, potassium oxide, calcium oxide, magnesium oxide, sodium hydroxide, potassium hydroxide, calcium hydroxide, magnesium hydroxide, sodium carbonate, potassium carbonate, sodium bicarbonate, calcium carbonate, magnesium carbonate and dolomite, CaMg(CO₃)₂ Mixtures of the foregoing materials may be used as the inorganic material.

The foregoing inorganic materials can be derived from naturally occurring minerals or from relatively pure compounds.

However, it will be appreciated that since large quantities of such inorganic materials will be utilized in the process of this invention, inexpensive sources of such inorganic materials are greatly preferred.

One particularly preferred source of the inorganic materials is naturally occurring limestone. Other preferred sources of the inorganic materials include lime and industrial waste materials that contain any of the foregoing components in appreciable quantities. Aqueous solutions or slurries of such materials, which are normally treated as waste products, are very attractive as sources of the inorganic materials.

Any suitable means for reducing the particle size of the inorganic materials can be utilized, such as by grinding, crushing and the like. However, particularly useful methods of forming the preferred very fine, porous particle are disclosed in the U.S. patents Faatz '498 and Veltman '130, both of which are incorporated herein in their entirety.

The present invention is distinguished from the very small scale, inadvertent dispersal of powders, for example, the dispersal of lime powders or limestone powders on lawns or from the blowing of powders during their transport in vehicles or industrial production lines and other processes. The present invention is distinguished from the aforementioned small scale dispersals by the intentional dispersal of stoichiometric amounts (or a substantial fraction thereof) or an excess of a stoichiometric amount of the inorganic material for neutralizing various acidic chemical substances in the atmosphere. The present invention is also distinguished from the aforementioned activities by the use of microscopic, even sub-microscopic particles.

In a preferred embodiment, the acid neutralizing materials are of such a fine nature as to travel much of the same pathway through the atmosphere as that of the emissions of the acidic pollutants in order to more effectively neutralize the acidic chemical substances emitted from the source.

A substantial portion is meant to include dispersing enough finely divided or pulverized acid neutralizing material into the atmosphere to neutralize from 1% up to 100%, or any amount in between, of the acid potential of the emissions of a source. Of course, dispersing enough finely divided or pulverized acid neutralizing material into the atmosphere to neutralize up to or more than 100% of the acid potential of the emissions of a source is encompassed within the present invention.

It is known to disperse fertilizers containing calcium carbonate from airplanes and helicopters by farm personnel in the preparation of a field for planting. The present invention is distinguished from this activity in that fertilizers are generally dispersed solely over a small area such as the field which is being prepared for planting. A major portion of the fertilizer generally travels only a short distance from the site of dispersal before the major portion of the fertilizer settles onto the ground. Moreover, in contrast to the present invention, the fertilizers are not dispersed with any proportionality to the emissions of any source of acidic chemical materials.

The present invention also includes the possibility of a governmental body or a non-governmental organization (ngo) intentionally dispersing acid neutralizing materials into the atmosphere in order to neutralize the acidic chemical substances emitted from a natural source, such as geysers or volcanoes, or from one or more manmade sources such a power plant and/or other industrial processes.

The following example is given to better illustrate the points of the present invention. For example, on any day a given region might have acidic chemical substances in the atmosphere, such as sulfuric acid, etc., from 1000 or more sources. On that day, a company may have emitted 100 tons of sulfur dioxide which may amount to only 0.1 percent of the sulfur dioxide that is present in the atmosphere for that region. To completely neutralize the acid producing effects of 100 tons of sulfur dioxide which will ultimately convert to sulfuric and sulfurous acids, the company or some other entity must disperse 172 tons of calcium carbonate material, if the carbonate in each particle reacts to completion with sulfuric acid or sulfurous acid formed from the 100 tons of sulfur dioxide. The 172 tons of calcium carbonate is the stoichiometric amount of calcium carbonate. The overall reaction is shown in equation (8) as follows:

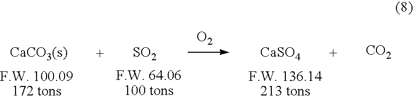

Of course, other acid neutralizing materials may be used in the appropriate amount, e.g. CaMg(CO₃)₂ will require 131 tons to completely neutralize the acid producing effects of 100 tons of sulfur dioxide, if the carbonate in each particle reacts to completion with sulfuric acid or sulfurous acid formed from 100 tons of sulfur dioxide. The 172 tons of calcium carbonate will react with whatever acidic chemical materials it encounters as it disperses through the atmosphere in the given region. There is no need that the acid neutralizing materials react exclusively with the acidic chemical materials emitted by the aforementioned company.

To be clear, the present invention refers to finely divided or pulverized acid neutralizing material dispersed into the atmosphere for neutralizing a substantial portion of the acidic chemical materials emitted from a source. This statement means that the finely divided or pulverized acid neutralizing material reacts with the acidic chemical materials in the atmosphere from any source, not necessarily only with acidic chemical materials that were emitted from a given source of the acidic chemical materials.

While there will be some diminution of the acid neutralizing effect of the dispersed particles when the inorganic materials are dispersed in quantities less than the stoichiometric amounts stated above, more complete acid neutralizing effect will be obtained when the above-mentioned molar ratios are at least stoichiometric.

While it is anticipated that the more preferred embodiment of the present invention is the dispersing of a powder, the present invention also encompasses dispersing the chemical base in other forms, including dispersing the chemical base by spraying a slurry of the fine powderous acid neutralizing materials. It is also encompasses in the instant invention the possibility of directly spraying metal bicarbonate solutions (whether supercritical or subcritical), with or without heating as the metal bicarbonate solutions is being sprayed, to form the acid neutralizing material as fine, porous metal carbonate particles.

The present invention also contemplates dispersing microscopic or sub-microscopic acid neutralizing particles in response to acidic pollutants from unknown sources or sources beyond the regulation of the local government. In such cases, the acid neutralizing particles are to be released in response to measured amounts of acidic pollutants.

In the United States, the U.S. Geological Survey (USGS) is the lead federal agency for the monitoring of wet atmospheric deposition (chemical constituents deposited from the atmosphere via rain, sleet and snow). The National Atmospheric Deposition Program (NADP) monitors wet atmospheric deposition at 250 National Trends Network (NTN) sites throughout the United States. The USGS supports 74 of the roughly 250 active NADP/NTN sites. In particular, the NADP program operates an acid rain observing network that is used to monitor the chemistry of precipitation for geographical and temporal long-term trends. Quality assured precipitation chemistry data (including acidity) and analyzed maps are provided. A fundamental NADP program objective is to provide scientific investigators world-wide with a long-term, high-quality database of atmospheric deposition for research support in the areas of air quality, water quality, agricultural effects, forest productivity, materials effects, ecosystem studies, watershed studies and human health.

In Canada, Ambient Air Monitoring is provided by the National Air Pollution Surveillance (NAPS) Network. The NAPS Network was established in 1969 as a way for the federal and provincial governments to work together on gathering and measuring accurate air quality data on various pollutants including acidic pollutants such as sulfur dioxide. The NAPS Network identifies and characterizes major sources of toxic air pollutants in long-range transport, and provides improved information on the fate of all these substances in the environment. The data are used to evaluate the progress of air pollution controls and to help direct future actions.

Once the measured data is available for the amount of acidic pollutants in a given region, then an appropriate amount of finely divided or pulverized acid neutralizing material can be released into the given region to neutralize a substantial fraction or all of the estimated acidic pollutants. For the purposes of this patent application, the phrase “a substantial fraction” means at least 1% of the whole, more preferably at least 5%, more preferably at least 10%, more preferably at least 20%, more preferably at least 50%, more preferably at least 75%.

A given region will generally be at least a square mile (2.6 km²) but usually much more. The finely divided or pulverized acid neutralizing material can be released from a number of sites to more effectively react in the atmosphere with the pollutants measured or estimated in the given region. However, the dispersal of the finely divided or pulverized acid neutralizing material almost certainly cannot be controlled with great precision. Fortunately, great precision is not needed to gain the advantages of the instant invention. Because of the variability of winds from day to day, the release of the finely divided or pulverized acid neutralizing material on a periodic basis will result in the finely divided or pulverized acid neutralizing material being more evenly dispersed over the region.

Once the amount of acidic pollutants in a given region has been determined, then the amount of finely divided or pulverized acid neutralizing material is calculated to stoichiometrically neutralize the effects of the acidic pollutant materials. Then the calculated amount, or any substantial fraction thereof, of finely divided or pulverized acid neutralizing material can be released into the given region. Even amounts of finely divided or pulverized acid neutralizing material greater than the calculated stoichiometric amount may be released into the given region with the effect of making the precipitation in the given region slightly basic, but still very healthy for the region. It is basically a political decision as to what fraction of the calculated stoichiometric amount of finely divided or pulverized acid neutralizing material will be used to neutralize atmospheric acidity in a given region. Whether to release the calculated amount, or any fraction thereof, or even greater than the calculated amount is a political decision since the how much finely divided or pulverized acid neutralizing material is released depends upon the objectives to be attained. For example, it may be decided that only a fraction of the acidic pollutant materials are likely to precipitate or dry deposit on the surface area of the given region with the remainder of the acidic pollutant materials blowing out of the given region or even out to the oceans. It is not an object of this invention to define what fraction of acidic pollutant materials are likely to precipitate or dry deposit on the surface area of the given region.

Alternatively, the amount of acidic precipitation in a given region can be determined based on a plurality of sampling sites such as that operated by the U.S. National Atmospheric Deposition Program (NADP). Then based on the measured amount of acid in the acidic precipitation for a given period of time, e.g. a few or several days, an amount of finely divided or pulverized acid neutralizing material is calculated to stoichiometrically neutralize the effects of the acidic precipitation. Then the calculated amount, or any substantial fraction thereof, of finely divided or pulverized acid neutralizing material can be released into the given region. Even amounts of finely divided or pulverized acid neutralizing material greater than the calculated stoichiometric amount may be released into the given region with the effect of making the precipitation in the given region slightly basic, but still very healthy for the region.

The finely divided or pulverized acid neutralizing material may include other metals such as iron, nickel, copper and/or zinc compounds, and other metals of the periodic table as well as non-metal substances such as selenium, chloride, iodide such that the finely divided or pulverized acid neutralizing material can be nutritionally beneficial for humans, animals and plants if inhaled or ingested, and can be beneficial more generally to the environment. The following compositional example is shown to give some guidance for this aspect of the present invention. Particular compounds for the various components may found in vitamin formulations, for example, and other known nutrient formulations.

TABLE 1
Example Compositions Useful in the Present Invention

| | |
|---|---|
| Calcium | 0-5000 mg (more preferably 200-2000 mg) |
| | (e.g. CaCO₃, CaO) |
| Magnesium | 0-5000 mg (more preferably 200-2000 mg) |
| | (e.g. MgCO₃, MgO) |
| Boron | 0-1.5 mg (more preferably 0-0.3 mg) |
| Chloride | 0-3,400 mg (more preferably 0-100 mg) |
| Chromium | 0-500 mcg (more preferably 0-200 mcg) |
| Cobalt | 0-0.6 mcg |
| Copper | 0-5 mg (more preferably 0-4 mg) |
| Iodine | 0-1 mg (more preferably 0-0.3 mg) |
| Iron | 0-100 mg (more preferably 0-20 mg) |
| Manganese | 0-10 mg (more preferably 0-4 mg) |
| Molybdenum | 0-750 mcg (more preferably 0-150 mcg) |
| Nickel | 0-25 mcg (more preferably 0-5 mcg) |
| Phosphorus | 0-1000 mg (preferably in the form of a MPO₄, |
| | M′HPO₄, M″H₂PO₄) |
| Potassium | 0-100 mg (more preferably 0-20 mg) |
| Selenium | 0-100 mcg (more preferably 0-20 mcg) |
| Silicon | 0-10 mg (more preferably 0-2 mg) |
| Sodium, | 0-1000 mg |
| Tin | 0-50 mcg (more preferably 0-10 mcg) |
| Vanadium | 0-50 mcg (more preferably 0-10 mcg) |
| Zinc | 0-150 mg (more preferably 0-30 mg) |
| Amino acids | |
| Betaine HCl | 0-100 mg (more preferably 0-20 mg) |
| Biotin | 0-300 mcg (more preferably 0-60 mcg) |
| Folate (Folic Acid) | 0-400 mcg (more preferably 0-80 mcg) |
| Glutamic Acid HCl | 0-100 mg (more preferably 0-20 mg) |
| Niacin | 0-20 mg (more preferably 0-4 mg) |
| Pantothenic acid | 0-10 mg (more preferably 0-2 mg) |
| Riboflavin | 0-1.7 mg. (more preferably 0-0.35 mg) |
| Vitamin A | 0-5,000 IU |
| Vitamin B1 (Thiamin) | 0-1.5 mg. (more preferably 0-0.3 mg) |
| Vitamin B2 (Riboflavin) | 0-1.7 mg. (more preferably 0-0.35 mg) |
| Vitamin B6 | 0-2 mg (more preferably 0-0.4 mg) |
| Vitamin B12 | 0-6.0 mcg (more preferably 0-1.2 mg) |
| Vitamin C | 0-60 mg (more preferably 0-12 mg) |
| Vitamin D | 0-400 IU |
| Vitamin E | 0-30 IU |
| Vitamin K | 0-80 mcg. |

Any other known nutrient, mineral, etc.

I claim:

1. A method for the neutralization of acidic chemical materials emitted from one or more man-made or natural sources into the atmosphere comprising:
dispersing finely divided or pulverized acid neutralizing material into the atmosphere wherein said finely divided or pulverized acid neutralizing material is dispersed in order to neutralize at least a substantial portion of said acidic chemical materials from one or more sources of emissions of said acidic chemical materials in the atmosphere.

2. The method of claim 1 wherein said finely divided or pulverized acid neutralizing material comprises an inorganic material.

3. The method of claim 2 wherein said inorganic material comprises a metallic oxide, hydroxide, carbonate, or a mixture thereof.

4. The method of claim 3 wherein said metallic oxide, hydroxide, carbonate, or a mixture thereof comprises:
an oxide of lithium, sodium, potassium, calcium, or magnesium;
a hydroxide of lithium, sodium, potassium, calcium, or magnesium;
a carbonate of lithium, sodium, potassium, calcium, or magnesium;
dolomite, calcite, limestone, marble.

5. The method of claim 1 wherein said finely divided or pulverized acid neutralizing material has an average particle size of one-thousandth of an inch (25 μm) or less.

6. The method of claim 1 wherein said finely divided or pulverized acid neutralizing material has an average particle size of 1 μm or less.

7. The method of claim 1 wherein said finely divided or pulverized acid neutralizing material has an average particle size of 0.4 μm or less.

8. The method of claim 1 wherein said finely divided or pulverized acid neutralizing material has an average particle size of 0.1 μm or less.

9. The method of claim 1 wherein said finely divided or pulverized acid neutralizing material has an average particle size of 0.02 μm or less.

10. The method of claim 1 wherein said finely divided or pulverized acid neutralizing material has an average particle size of 0.01 μm or less.

11. The method of claim 1 wherein said finely divided or pulverized acid neutralizing material does not contain more than an insubstantial amount of water insoluble or non-metabolizable material and does not contain more than a trace amount of toxic components.

12. The method of claim 11 wherein said insubstantial amount is not more than 1% by weight of the total weight of said finely divided or pulverized acid neutralizing material and said trace amount of toxic components is not more than 0.01% by weight of the total weight of the acid neutralizing material.

13. The method of claim 11 wherein said insubstantial amount is not more than 0.1% by weight of the total weight of an average particle of said finely divided or pulverized acid neutralizing material and said trace amount of toxic components is not more than 0.001% by weight of the total weight of the acid neutralizing material.

14. The method of claim 11 wherein said insubstantial amount is not more than 0.01% by weight of the total weight of an average particle of said finely divided or pulverized acid neutralizing material and said trace amount of toxic components is not more than 0.0001% by weight of the total weight of the acid neutralizing material.

15. A method of reducing atmospheric acidity and acid precipitation comprising: dispersing into a given region an amount of finely divided or pulverized acid neutralizing material sufficient to neutralize at least a substantial fraction of the atmospheric acidity that is estimated or measured for said region.

16. The method of claim 15 wherein said finely divided or pulverized acid neutralizing material has an average particle size of less than 10 μm or less.

17. The method of claim 15 wherein said finely divided or pulverized acid neutralizing material has an average particle size of less than 1.0 μm or less.

18. The method of claim 15 wherein said finely divided or pulverized acid neutralizing material has an average particle size of less than 0.4 μm or less.

19. The method of claim 15 wherein said finely divided or pulverized acid neutralizing material has an average particle size of less than 0.1 μm or less.

20. The method of claim 15 wherein said finely divided or pulverized acid neutralizing material has an average particle size of less than 0.02 μm or less.

21. The method of claim 15 wherein said finely divided or pulverized acid neutralizing material does not contain more than an insubstantial amount of water insoluble or non-metabolizable material and does not contain more than a trace amount of toxic components.

22. The method of claim 15 wherein said insubstantial amount is not more than 1% by weight of the total weight of said finely divided or pulverized acid neutralizing material and said trace amount of toxic components is not more than 0.01% by weight of the total weight of the acid neutralizing material.

23. The method of claim 15 wherein said insubstantial amount is not more than 0.1% by weight of the total weight of an average particle of said finely divided or pulverized acid neutralizing material and said trace amount of toxic components is not more than 0.001% by weight of the total weight of the acid neutralizing material.

24. The method of claim 15 wherein said insubstantial amount is not more than 0.01% by weight of the total weight of an average particle of said finely divided or pulverized acid neutralizing material and said trace amount of toxic components is not more than 0.0001% by weight of the total weight of the acid neutralizing material.

25. A method of reducing the acidity of fallen precipitation comprising: dispersing into a given region an amount of finely divided or pulverized acid neutralizing material sufficient to neutralize at least a substantial fraction of the acidic precipitation that has been estimated or measured for said region.

26. The method of claim 25 wherein said finely divided or pulverized acid neutralizing material has an average particle size of 10 μm or less.

27. The method of claim 25 wherein said finely divided or pulverized acid neutralizing material has an average particle size of 1.0 μm or less.

28. The method of claim 25 wherein said finely divided or pulverized acid neutralizing material has an average particle size of 0.4 μm or less.

29. The method of claim 25 wherein said finely divided or pulverized acid neutralizing material has an average particle size of 0.1 μm or less.

30. The method of claim 25 wherein said finely divided or pulverized acid neutralizing material does not contain more than an insubstantial amount of water insoluble or non-metabolizable material and does not contain more than a trace amount of toxic components.

31. The method of claim 25 wherein said insubstantial amount is not more than 1% by weight of the total weight of said finely divided or pulverized acid neutralizing material and said trace amount of toxic components is not more than 0.01% by weight of the total weight of the acid neutralizing material.

32. The method of claim 25 wherein said insubstantial amount is not more than 0.1% by weight of the total weight of an average particle of said finely divided or pulverized acid neutralizing material and said trace amount of toxic components is not more than 0.001% by weight of the total weight of the acid neutralizing material.

33. The method of claim 25 wherein said insubstantial amount is not more than 0.01% by weight of the total weight of an average particle of said finely divided or pulverized acid neutralizing material and said trace amount of toxic components is not more than 0.0001% by weight of the total weight of the acid neutralizing material.
